(19) United States
(12) Patent Application Publication
(10) Pub. No.: US 2015/0063206 A1
(43) Pub. Date: Mar. 5, 2015

(54) METHOD AND APPARATUS FOR LOCAL AREA NETWORK IMPLEMENTATION

(71) Applicant: Nokia Corporation, Espoo (FI)

(72) Inventors: Jarkko Lauri Sakari Kneckt, Espoo (FI); Päivi Marjut Ruuska, Kristiansand (NO); Ari Hottinen, Espoo (FI)

(73) Assignee: Nokia Corporation, Espoo (FI)

(21) Appl. No.: 14/240,742

(22) PCT Filed: Sep. 9, 2011
(86) PCT No.: PCT/IB2011/002109

§ 371 Date: Feb. 24, 2014

(51) Int. Cl. H04W 16/14; H04W 48/16

(52) U.S. Cl. CPC H04W 16/14; H04W 48/16
USPC 370/328

(57) ABSTRACT

Various methods are described for implementing secondary networks for cooperative communications with a primary network. One example method may include providing for connection to a primary network. The method of this example embodiment may further include receiving configuration information comprising one or more criteria for connecting to a secondary network. Furthermore, the method of this example embodiment may include providing for connection to the secondary network based at least in part on the one or more criteria. The method of this example embodiment may further include causing communication of data with a network entity in the primary network in cooperation with one or more devices connected to the secondary network. Similar and related example methods, example apparatuses, and example computer program products are also provided.

### TECHNICAL FIELD

Embodiments of the present invention relate generally to communication technology, and, more particularly, relate to a method, apparatus, and computer program product for implementing secondary networks for cooperative communications with a primary network.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. In order to provide easier or faster information transfer and convenience, telecommunication industry service providers are developing improvements to existing networks. In this regard, for example, improvements are being made to the universal mobile telecommunications system (UMTS) terrestrial radio access network (UTRAN). Further, for example, the evolved-UTRAN (E-UTRAN) is currently being developed. The E-UTRAN, which is also known as Long Term Evolution (LTE), is aimed at upgrading prior technologies by improving efficiency, lowering costs, improving services, making use of new spectrum opportunities, and providing better integration with other open standards.

Additionally, telecommunications devices are being developed that connect to radio networks as well as other networks such as local area networks. In this way, a device may be able to offload certain communications from the radio networks to the local area networks, which may serve to alleviate the burden placed on the radio networks. Systems supporting such functionality typically rely on pre-existing local area networks that provide an access point to the Internet. Furthermore, devices operating in these systems generally conduct communications independently without regard to the other devices connected to the same local area network.

Accordingly, it may be desirable to provide systems, methods, apparatuses, and computer program products for implementing secondary networks for cooperative communications with a primary network.

### SUMMARY

In a wide area network, a base station cell may be connected to multiple devices operating within the network at any given time. A network operator may wish for certain devices to join or establish local area networks (LANs) to assist with cooperative communications and/or offloading to help reduce network traffic. The network operator may further desire to provide rules and criteria for when certain devices should join and/or establish certain LANs. The network operator may also wish to prevent certain devices lacking the necessary capabilities or exceeding a certain distance from other devices from joining a particular LAN and/or participating in cooperative communications. A need, therefore, exists to allow a network operator to provide configuration information to terminal apparatuses that instruct them when to join and/or establish such LANs for the purposes described above. Various embodiments of the invention described below seek to offer solutions to the problem by providing apparatuses and methods for implementing secondary networks for cooperative communications with a primary network.

Methods, apparatuses, and computer program products are herein provided for implementing secondary networks for cooperative communications with a primary network. Systems, methods, apparatuses, and computer program products in accordance with various embodiments may provide several advantages to computing devices, computing device users, and network providers. Some example embodiments advantageously enable a network entity, such as a base station, to distribute instructions to connected devices instructing when the devices should join and/or establish LANs. In this regard, the base station may provide the information to the devices via a static Access Network Discovery and Selection Function Management Object or, in certain embodiments, real time commands. Once connected to these LANs, various embodiments advantageously allow the devices to offload certain traffic through an Internet portal offered by the LAN. For example, the Internet portal may connect the LAN to another network that forwards traffic to the Internet. In other embodiments, the devices may cooperate with each other to send and receive data to and from the base station. For example, a device may distribute the data to be transmitted to other devices in the LAN, and all of the devices may then transmit the same data to the base station at the same time, for example using cooperative multiple-input and multiple-output (MIMO) communications. Cooperative communication among local network devices may enable more power efficient transmissions to the wide area network. For example, each device may require less power to transmit to a base station in the wide area network due to the distribution of the transmission across multiple devices. Similar methods may be used to receive data from the base station in cooperation with other devices. Collaborative reception according to some embodiments may advantageously allow a device in the LAN to receive the data from the base station and forward the data to the device in the LAN for which it is destined, thereby reducing the active wide area reception time for the one or more devices of the LAN.

Some advantageous embodiments allow a network entity, such as a base station, to monitor the various LANs operating in the area. The base station, in various embodiments, may instruct certain devices to establish, join, change, or disconnect from particular LANs in order to control at least the number, size, frequency usage, and location of LANs in the area. In this regard, a base station may have improved control over the routing and traffic within the wide area network through the use of the LANs. By monitoring the position of the devices (e.g., via geolocation), available LANs, and the current traffic and congestion of the wide area networks, example advantageous embodiments may allow the base station to determine when a device should or should not be connected to a LAN. In this way, the devices may be able to reduce power consumption by avoiding constant connection to the LANs and/or continuous attempts to search for and/or initiate LANs (e.g., listening for and/or transmitting a beacon) when unnecessary.

In an example embodiment, a method is provided, which may comprise providing for connection to a primary network. The method of this example embodiment may further comprise receiving configuration information comprising one or more criteria for connecting to a secondary network. The method of this example embodiment may also comprise providing for connection to the secondary network based at least in part on the one or more criteria. The method of this example embodiment may further comprise causing communication of data with a network entity in the primary network in cooperation with one or more devices connected to the secondary network. In another embodiment, a computer program may be provided for executing the various operations of the example method.

In another example embodiment, an apparatus comprising at least one processor and at least one memory storing computer program code is provided. The at least one memory and stored computer program code may be configured, with the at least one processor, to cause the apparatus of this example embodiment to at least provide for connection to a primary network. The at least one memory and stored computer program code may be configured, with the at least one processor, to further cause the apparatus of this example embodiment to receive configuration information comprising one or more criteria for connecting to a secondary network. Furthermore, the at least one memory and stored computer program code may be configured, with the at least one processor, to cause the apparatus of this example embodiment to provide for connection to the secondary network based at least in part on the one or more criteria. The at least one memory and stored computer program code may be configured, with the at least one processor, to further cause the apparatus of this example embodiment to cause communication of data with a network entity in the primary network in cooperation with one or more devices connected to the secondary network.

In another example embodiment, a computer program product is provided. The computer program product of this example embodiment may comprise at least one computer-readable storage medium having computer-readable program instructions stored therein. The program instructions of this example embodiment may comprise program instructions configured to provide for connection to a primary network. The program instructions of this example embodiment may further comprise program instructions configured to receive configuration information comprising one or more criteria for connecting to a secondary network. Furthermore, the program instructions of this example embodiment may comprise program instructions configured to provide for connection to the secondary network based at least in part on the one or more criteria. The program instructions of this example embodiment may further comprise program instructions configured to cause communication of data with a network entity in the primary network in cooperation with one or more devices connected to the secondary network.

In another example embodiment, an apparatus is provided, which may comprise means for providing for connection to a primary network. The apparatus of this example embodiment may further comprise means for receiving configuration information comprising one or more criteria for connecting to a secondary network. Furthermore, the apparatus of this example embodiment may comprise means for providing for connection to the secondary network based at least in part on the one or more criteria. The apparatus of this example embodiment may further comprise means for causing communication of data with a network entity in the primary network in cooperation with one or more devices connected to the secondary network.

In an example embodiment, a method is provided, which may comprise accepting a primary network connection from one or more devices. The method of this example embodiment may further comprise causing transmission of configuration information to the one or more devices. The configuration information may comprise one or more criteria for connecting to a secondary network. Furthermore, the method of this example embodiment may comprise providing for communication of data with a plurality of the one or more devices. The data may originate or terminate with one of the one or more devices, and the plurality of the one or more devices may be connected to the secondary network. In another embodiment, a computer program may be provided for executing the various operations of the example method.

In an example embodiment, an apparatus comprising at least one processor and at least one memory storing computer program code is provided. The at least one memory and stored computer program code may be configured, with the at least one processor, to cause the apparatus of this example embodiment to at least accept a primary network connection from one or more devices. The at least one memory and stored computer program code may be configured, with the at least one processor, to further cause the apparatus of this example embodiment to cause transmission of configuration information to the one or more devices. The configuration information may comprise one or more criteria for connecting to a secondary network. The at least one memory and stored computer program code may be configured, with the at least one processor, to further cause the apparatus of this example embodiment to provide for communication of data with a plurality of the one or more devices. The data may originate or terminate with one of the one or more devices, and the plurality of the one or more devices may be connected to the secondary network.

In another example embodiment, a computer program product is provided. The computer program product of this example embodiment may comprise at least one computer-readable storage medium having computer-readable program instructions stored therein. The program instructions of this example embodiment may comprise program instructions configured to accept a primary network connection from one or more devices. The program instructions of this example embodiment may further comprise program instructions configured to cause transmission of configuration information to the one or more devices. The configuration information may comprise one or more criteria for connecting to a secondary network. Furthermore, the program instructions of this example embodiment may comprise program instructions configured to provide for communication of data with a plurality of the one or more devices. The data may originate or terminate with one of the one or more devices, and the plurality of the one or more devices may be connected to the secondary network.

In another example embodiment, an apparatus is provided, which may comprise means for accepting a primary network connection from one or more devices. The method of this example embodiment may further comprise means for causing transmission of configuration information to the one or more devices. The configuration information may comprise one or more criteria for connecting to a secondary network. Furthermore, the method of this example embodiment may comprise means for providing for communication of data with a plurality of the one or more devices. The data may originate or terminate with one of the one or more devices, and the plurality of the one or more devices may be connected to the secondary network.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described some example embodiments of the invention in general terms, reference will now be made to the accompanying drawings, which are not necessarily drawn to scale, and wherein:

FIG. 1 illustrates a system for implementing secondary networks for cooperative communications with a primary network according to some example embodiments of the present invention;

FIG. 2 illustrates a schematic block diagram of a mobile terminal according to some example embodiments of the present invention;

FIG. 3 illustrates a block diagram of a terminal apparatus according to some example embodiments of the present invention.

FIG. 4 illustrates a block diagram of a serving network apparatus according to some example embodiments of the present invention.

FIG. 5 illustrates a flowchart according to an example method for implementing secondary networks for cooperative communications with a primary network according to some example embodiments of the present invention;

FIG. 6 illustrates a flowchart according to an example method for implementing secondary networks for cooperative communications with a primary network according to some example embodiments of the present invention;

FIGS. 7A through 7D illustrate an example embodiment for connecting terminal apparatuses to a secondary network for cooperative communication.

FIG. 8 illustrates a table of additional information elements that may be added to an Access Network Discovery and Selection Function Management Object.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of computer-readable media include a floppy disk, a flexible disk, hard disk, magnetic tape, any other magnetic medium, a compact disc read only memory (CD-ROM), compact disc compact disc-rewritable (CD-RW), digital versatile disc (DVD), Blu-Ray, any other optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

As used herein, the term ‘connecting to’ with respect to a network (e.g., “connecting to a secondary network”) may refer to either joining a preexisting network or forming a new network (e.g., an ad hoc network) to which other devices may join. This definition of ‘connecting to’ applies to all uses of this term in this application, including in any claims.

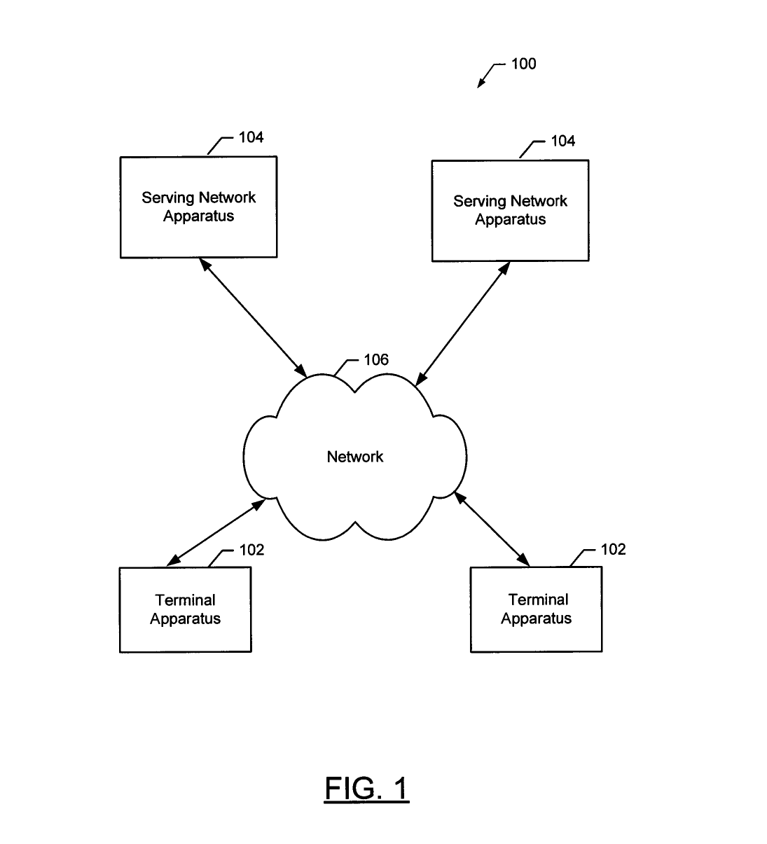

Referring now to FIG. 1, FIG. 1 illustrates a block diagram of a system 100 for implementing secondary networks for cooperative communications with a primary network according to an example embodiment. It will be appreciated that the system 100 as well as the illustrations in other figures are each provided as an example of one embodiment and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for implementing secondary networks for cooperative communications with a primary network, numerous other configurations may also be used to implement embodiments of the present invention.

The system 100 may include one or more terminal apparatuses 102 and one or more serving network apparatuses 104. The system 100 may further comprise a network 106. The network 106 may comprise one or more wireline networks, one or more wireless networks, or some combination thereof. The network 106 may, for example, comprise a serving network (e.g., a serving cellular network) for one or more terminal apparatuses 102. The network 106 may comprise, in certain embodiments, one or more of the terminal apparatuses 102 and serving network apparatuses 104 themselves. In some embodiments, the network 106 may comprise a public land mobile network (for example, a cellular network), such as may be implemented by a network operator (for example, a cellular access provider). The network 106 may operate in accordance with universal terrestrial radio access network (UTRAN) standards, evolved UTRAN (E-UTRAN) standards, current and future implementations of Third Generation Partnership Project (3GPP) LTE (also referred to as LTE-A) standards, current and future implementations of International Telecommunications Union (ITU) International Mobile Telecommunications-Advanced (IMT-A) systems standards, and/or the like. It will be appreciated, however, that where references herein are made to a network standard and/or terminology particular to a network standard, the references are provided merely by way of example and not by way of limitation.

According to various embodiments, one or more terminal apparatuses 102 may be configured to connect directly with one or more serving network apparatuses 104 via, for example, an air interface without routing communications via one or more elements of the network 106. Alternatively, one or more of the terminal apparatuses 102 may be configured to communicate with one or more of the serving network apparatuses 104 over the network 106. In this regard, the serving network apparatuses 104 may comprise one or more nodes of the network 106. For example, in some example embodiments, the serving network apparatuses 104 may be at least partially embodied on one or more computing devices that comprise an element of a radio access network (RAN) portion of the network 106. In this regard, the serving network apparatuses 104 may, for example, be at least partially embodied on an access point of the network 106 (for example, a macrocell, microcell, picocell, femtocell, closed subscriber group (CSG) cell, base station, base transceiver station (BTS), node B, evolved node B, access point (AP), group owner, mesh station (STA), mesh point, and/or the like), which may, for example be configured to provide access to the network 106 (e.g., via a radio uplink) to one or more of the terminal apparatuses 102. In some embodiments, the serving network apparatuses 104 may comprise an Access Network Discovery and Selection Function (ANDSF), a Real Time Secondary Access Network Discovery and Selection Function (RTSANDSF), and/or the like. Accordingly, each of the serving network apparatuses 104 may comprise a network node or a plurality of network nodes collectively configured to perform one or more operations attributed to the serving network apparatus 104 as described with respect to various example embodiments disclosed herein.

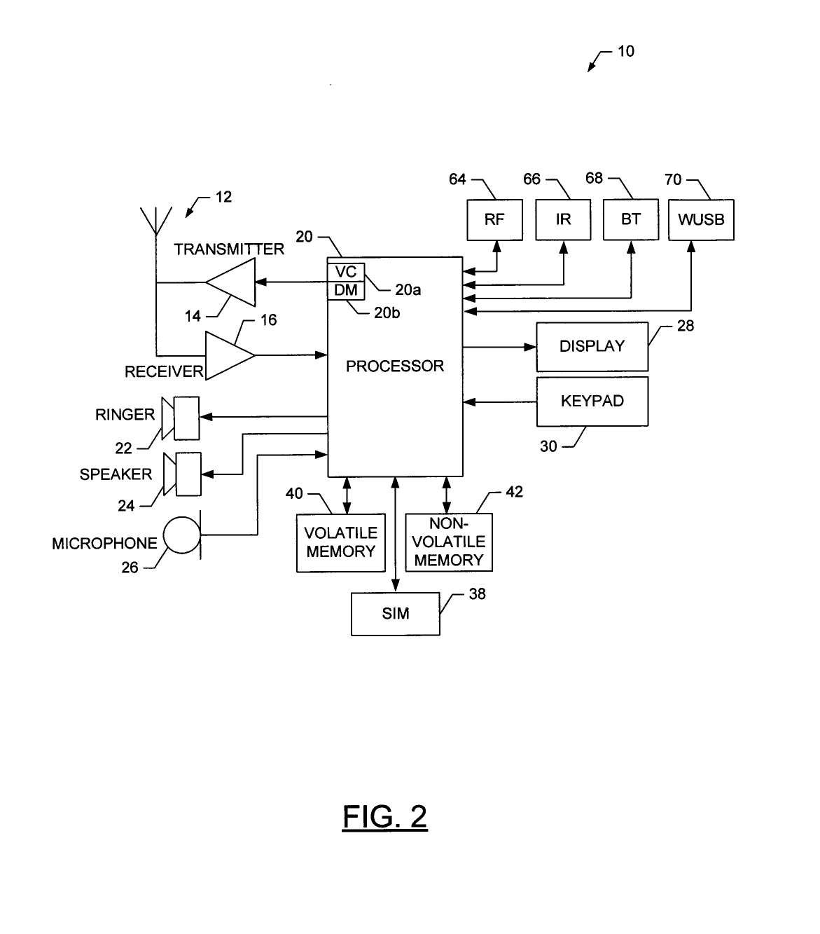

A terminal apparatus 102 may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), fixed transceiver device (e.g., attached to traffic lights, energy meters, light bulbs, and/or the like), any combination thereof, and/or the like. In an example embodiment, a terminal apparatus 102 may be embodied as a mobile terminal, such as that illustrated in FIG. 2.

In this regard, FIG. 2 illustrates a block diagram of a mobile terminal 10 representative of one embodiment of a terminal apparatus 102. It should be understood, however, that the mobile terminal 10 illustrated and hereinafter described is merely illustrative of one type of terminal apparatus 102 that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Bluetooth™ (BT), Ultra-wideband (UWB), Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols such as LTE Advanced and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to low power or ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

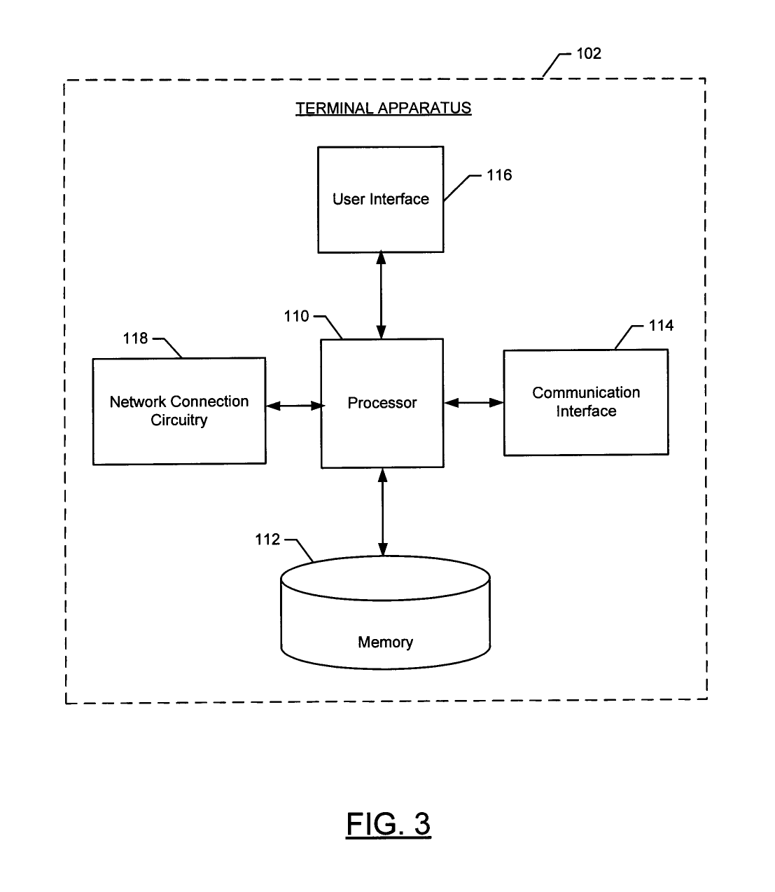

Referring now to FIG. 3, FIG. 3 illustrates a block diagram of a terminal apparatus 102 according to an example embodiment. In the example embodiment, the terminal apparatus 102 includes various means for performing the various functions herein described. These means may comprise one or more of a processor 110, memory 112, communication interface 114, user interface 116, or network connection circuitry 118. The means of the terminal apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (for example memory 112) that is executable by a suitably configured processing device (e.g., the processor 110), or some combination thereof.

In some example embodiments, one or more of the means illustrated in FIG. 3 may be embodied as a chip or chip set. In other words, the terminal apparatus 102 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 110, memory 112, communication interface 114, user interface 116, and/or network connection circuitry 118 may be embodied as a chip or chip set. The terminal apparatus 102 may therefore, in some example embodiments, be configured to implement embodiments of the present invention on a single chip or as a single “system on a chip.” As another example, in some example embodiments, the terminal apparatus 102 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 110 comprises a plurality of processors. The plurality of processors may be in operative communication with each other and may be collectively configured to perform one or more functionalities of the terminal apparatus 102 as described herein. The plurality of processors may be embodied on a single computing device or distributed across a plurality of computing devices collectively configured to function as the terminal apparatus 102. In embodiments wherein the terminal apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the terminal apparatus 102 to perform one or more of the functionalities of the terminal apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise one or more tangible and/or non-transitory computer-readable storage media that may include volatile and/or non-volatile memory. Although illustrated in FIG. 3 as a single memory, the memory 112 may comprise a plurality of memories. The plurality of memories may be embodied on a single computing device or may be distributed across a plurality of computing devices collectively configured to function as the terminal apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the terminal apparatus 102 is embodied as a mobile terminal 10, the memory 112 may comprise the volatile memory 40 and/or the non-volatile memory 42. The memory 112 may be configured to store information, data, applications, instructions, or the like for enabling the terminal apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. This stored information may be stored and/or used by the network connection circuitry 118 during the course of performing its functionalities.

The communication interface 114 may be embodied as any device or means embodied in circuitry, hardware, a computer program product comprising computer readable program instructions stored on a computer readable medium (for example, the memory 112) and executed by a processing device (for example, the processor 110), or a combination thereof that is configured to receive and/or transmit data from/to another computing device. In an example embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the terminal apparatus 102 and one or more computing devices or computing resources may be in communication. As an example, the communication interface 114 may be configured to enable communication between the terminal apparatus 102 and another device, such as another terminal apparatus 102. As a further example, the communication interface 114 may be configured to enable communication with a serving network apparatus 104 via the network 106. The communication interface 114 may additionally be in communication with the memory 112, user interface 116, and/or network connection circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In embodiments wherein the user interface 116 comprises a touch screen display, the user interface 116 may additionally be configured to detect and/or receive indication of a touch gesture or other input to the touch screen display. The user interface 116 may be in communication with the memory 112, communication interface 114, and/or network connection circuitry 118, such as via a bus.

The network connection circuitry 118 may be embodied as various means, such as circuitry, hardware, a computer program product comprising computer readable program instructions stored on a computer readable medium (for example, the memory 112) and executed by a processing device (for example, the processor 110), or some combination thereof and, in some embodiments, is embodied as or otherwise controlled by the processor 110. In embodiments wherein the network connection circuitry 118 is embodied separately from the processor 110, the network connection circuitry 118 may be in communication with the processor 110. The network connection circuitry 118 may further be in communication with one or more of the memory 112, communication interface 114, or user interface 116, such as via a bus.

In some example embodiments, the network connection circuitry 118 may be configured to provide for connection with a network service according to a given network standard. For example, the network connection circuitry 118 may be configured to provide for connection to a network service operating according to the LTE standard. In certain embodiments, the network connection circuitry 118 may be configured to connect to one or more serving network apparatuses 104 in order to provide for connection to a network 106.

According to various embodiments, the network connection circuitry 118 may be configured to receive information for non-cellular communication from a serving network apparatus 104. For example, the network connection circuitry 118 may be configured to receive an Access Network Discovery and Selection Function (ANDSF) Management Object (MO) from a serving network apparatus 104 operating in a primary network, such as from an ANDSF server (in certain embodiments via one or more intervening serving network apparatuses 104). In some instances, the network connection circuitry 118 may be configured to request the ANDSF MO from a serving network apparatus 104. The network connection circuitry 118 may provide for storage of the ANDSF MO. In this regard, a network connection circuitry 118 may not be required to request or receive the ANDSF MO in instances in which the network connection circuitry 118 already has a copy of the ANDSF MO in accessible storage. For example, the network connection circuitry 118 may have received the ANDSF MO earlier in the session with the primary network, during a previous session, via download from a service provider, and/or the like.

According to example embodiments, the ANDSF MO may provide the network connection circuitry 118 with information related to discovery of and connection to non-cellular networks, such as non-3GPP networks. In this regard, the ANDSF MO may be configured to provide one or more rules to the network connection circuitry 118 for determining when to connect to a non-cellular network. The ANDSF MO may be configured according to 3GPP Technical Specification 24.312, which is incorporated herein by reference in its entirety.

In example embodiments, the ANDSF MO may further be configured to provide information to the network connection circuitry 118 for establishing (i.e. forming) a secondary non-cellular network, for example an ad hoc local area network (LAN), or for connecting to such a network established by another terminal apparatus 102. In this regard, the ANDSF MO may comprise additional information elements or parameters related to such functionality.

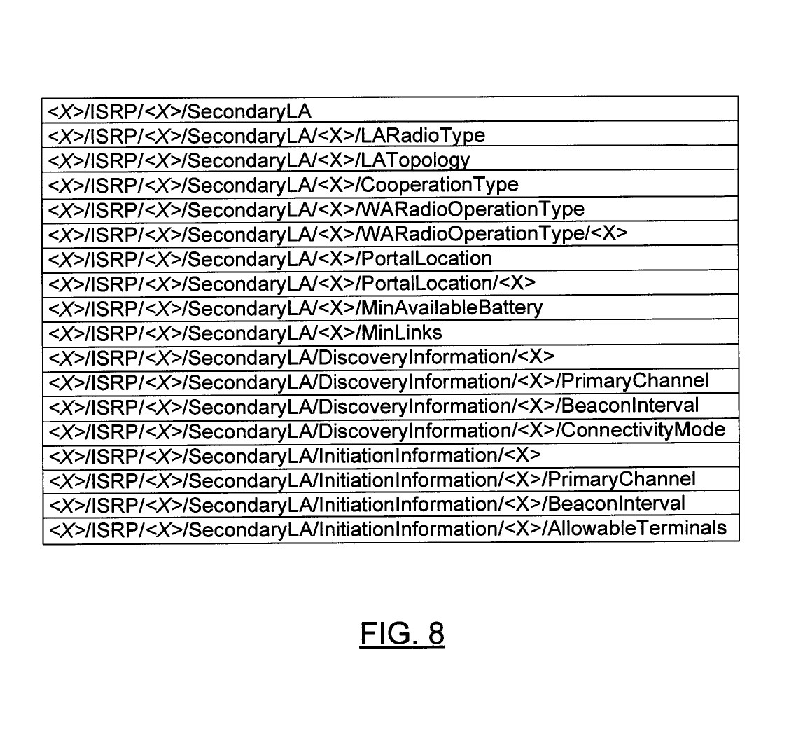

FIG. 8 provides a table of additional information elements that may be added to the ANDSF MO to create an extended ANDSF MO, according to one example embodiment. It should be understood that the additional information elements illustrated in FIG. 8 and hereinafter described are merely illustrative of one example embodiment and, therefore, should not be taken to limit the scope of the disclosure.

As shown in the example embodiment of FIG. 8, the extended ANDSF MO may comprise a SecondaryLA node representing a secondary network, such as an operator-specific LAN. The information provided to the network connection circuitry 118 in the SecondaryLA node may help the network connection circuitry 118 discover and/or establish an ad hoc secondary network, such as an ad hoc LAN. The extended ANDSF MO may comprise various placeholder nodes, represented by <X>, within the SecondaryLA node.

In certain embodiments, the extended ANDSF MO may comprise a leaf named LARadioType. The LARadioType leaf may indicate the type of radio to be used for the secondary network (e.g., an ad hoc LAN). For example, the LARadioType leaf may indicate that the radio type is 802.11a, 802.11b, 802.11g, 802.11n, 802.11s, 802.11ac, BT, UWB, and/or the like.

According to some embodiments, the extended ANDSF MO may comprise a leaf named LATopology. The LATopology leaf may indicate the purpose for joining or creating the secondary network. For example, the LATopology leaf may indicate that the secondary network is to be configured as an ad hoc local area network, independent basic service set (IBSS), mesh network, peer-to-peer (P2P) network, device-to-device (D2D) network, Nokia® Instant Community (NIC), and/or the like.

According to some embodiments, the extended ANDSF MO may comprise a leaf named CooperationType. The CooperationType leaf may indicate the type of transmissions that may be transmitted in the secondary network (e.g., an ad hoc LAN). The CooperationType leaf may, in certain embodiments, enable the secondary network to transmit uplink data (i.e., from the source of the data to cooperative transmitters of the data), downlink data (i.e., to the destination of the data from cooperative receivers of the data), or both uplink and downlink data. According to various embodiments, the CooperationType leaf may enable the secondary network to provide for local device, application, and service discovery, local data transmission, and/or a combination of these modes. In other embodiments, the CooperationType leaf may enable free usage of the secondary network for any transmission or usage type. According to other embodiments, the CooperationType leaf may indicate that the secondary network may provide for offloading to other terminal apparatuses 102 or other devices in the network 106

In various embodiments, the extended ANDSF MO may comprise a node named WARadioOperationType. The WARadioOperationType node may indicate the radio type of the primary network (e.g., a WAN), and the transmission and/or reception formats that the terminal apparatuses 102 in the secondary network will execute, such as when cooperatively communicating with the primary network. For example, the WARadioOperationType node may indicate that the primary network is configured to operate according to a particular mode when cooperatively communicating with primary network, such as an LTE mode. Some examples of an LTE mode may include an LTE cooperative uplink (UL) mode, an LTE cooperative downlink (DL) mode, an LTE cooperative UL and DL mode, and/or the like. The WARadioOperationType node may for example indicate the channels (e.g., frequency, timeslots, and/or the like) where the cooperative communication to and/or from the secondary network terminals from and/or to the primary network may take place. In some instances, the WARadioOperationType parameter may indicate that no special primary network operation mode is necessary.

According to example embodiments, the extended ANDSF MO may comprise a node named PortalLocation. The PortalLocation node may indicate the location of one or more portal devices, such as serving network apparatuses 104, configured to forward traffic from the secondary network to the Internet. For example, the PortalLocation node may indicate a base station or router through which one or more terminal apparatuses 102 in the secondary network may connect to the Internet. In some instances, the PortalLocation node may further indicate the name of the one or more portals. The PortalLocation field may also be set to zero in embodiments in which the secondary network does not comprise a portal.

In some embodiments, the extended ANDSF MO may comprise a leaf named MinAvailableBattery. The MinAvailableBattery leaf may indicate the minimum battery level required for a terminal apparatus 102 to access the secondary network. For example, the MinAvailableBattery leaf may indicate that the terminal apparatus 102 must have a wired power connection (e.g., mains powered), a certain minimum percentage of battery power remaining (e.g., more than 80% battery remaining), and/or the like. The MinAvailableBattery field may indicate that no battery limitations exist. In some instances, a terminal apparatus 102 may be able to override the MinAvailableBattery requirement (e.g., based on user input at the terminal apparatus 102).

According to various embodiments, the extended ANDSF MO may comprise a leaf named MinLinks. The MinLinks leaf may indicate the minimum number of links to neighboring devices (e.g., terminal apparatuses 102) that a terminal apparatus 102 must establish and/or maintain in order to join or establish the secondary network. The MinLinks may be based on the minimum number of links necessary for the secondary network to operate properly. For example, a terminal apparatus 102 may have ten neighboring devices, and the MinLinks field may indicate that the terminal apparatus 102 must maintain a link to at least two of those ten neighboring devices.

In example embodiments, the extended ANDSF MO may comprise a node named DiscoveryInformation. The DiscoveryInformation node may indicate various types of discovery information to be used for the secondary network. In some embodiments, the DiscoveryInformation node may comprise a placeholder node <X>, which may further comprise PrimaryChannel and BeaconInterval leaves. The PrimaryChannel leaf may indicate the lowest channel number (e.g., IEEE channel number) that the primary channel of the secondary network may use. In this regard, a terminal apparatus 102 may know the appropriate channel to use for performing network discovery in the secondary network. The BeaconInterval field may indicate the maximum duration between two consecutive beacon transmissions. In this way, a terminal apparatus 102 may use this information to determine whether a beacon message should have been received by a certain time when listening for a beacon. According to some embodiments, the DiscoveryInformation node may comprise a NetworkIdentification leaf. The NetworkIdentification leaf may provide an indication of the identity (e.g., a network name or service set identifier (SSID)) of the secondary network to which the terminal apparatus 102 associated with the network connection circuitry 118 may join. As such, the DiscoveryInformation node may provide information that allows a terminal apparatus 102 to reduce or conserve power during network discovery, for example by locating the secondary network and/or associated devices more rapidly and without unnecessary delay. In some embodiments, the DiscoveryInformation node may comprise a ConnectivityMode leaf. The ConnectivityMode leaf may provide an indication of the connectivity mode, such as passive scan, active scan, and/or the like. In certain instances, the connectivity mode may be technology specific. For example, the connectivity mode may depend on the radio type indicated by the LARadioType leaf.

In some embodiments, the extended ANDSF MO may comprise a node named InitiationInformation. The InitiationInformation node may comprise PrimaryChannel and BeaconInterval leaves similar to those described above with respect to the DiscoveryInformation node. In these embodiments, the PrimaryChannel and BeaconInterval leaves of the InitiationInformation node may relate to the operation of a secondary network initiated by the network connection circuitry 118 rather than a preexisting secondary network. In certain embodiments, the InitiationInformation node may comprise an AllowableTerminals node. The AllowableTerminals node may indicate one or more terminal apparatuses 102 that may be permitted to join the secondary network initiated by the network connection circuitry 118. For example, the AllowableTerminals node may provide an indication of the identity of the allowable terminal apparatuses by name, SSID, and/or the like.

As noted above, the additional parameters of the extended ANDSF MO depicted in FIG. 8 may be modified or further expanded. The extended ANDSF MO may rely on the various preexisting parameters of the standard ANDSF MO. For example, parameters related to location may define the locations where a secondary network should be created or should exist, and parameters related to time may define the time at which a secondary network should be created or should exist.

According to various embodiments, the network connection circuitry 118 may be configured to evaluate the ANDSF MO or extended ANDSF MO. In particular, the network connection circuitry 118 may be configured to evaluate the extended ANDSF MO to determine whether the network connection circuitry 118 should attempt to join or establish a secondary network. The ANDSF MO may indicate various criteria and/or rules that the network connection circuitry 118 may use to perform the evaluation. For example, the criteria may indicate a location and/or time of day relating to where and/or when a network connection circuitry 118 should attempt to join or establish a secondary network. In some embodiments, the criteria may also be based on information from the extended ANDSF MO described above with respect to FIG. 8. For example, the criteria may specify the minimum available battery power and/or minimum number of links related to the terminal apparatus 102 associated with the network connection circuitry 118 necessary before joining or establishing a secondary network.

In example embodiments, the network connection circuitry 118 may be configured to provide for connection to a preexisting secondary network (e.g. an existing LAN). In this regard, the network connection circuitry 118 may be configured to perform network discovery to detect and join the secondary network. The preexisting secondary network may comprise one or more connected terminal apparatuses 102, one or more wired and/or wireless routers, one or more microcells, and/or the like. The preexisting secondary network may be configured to provide a portal to the Internet for the one or more connected terminal apparatuses 102, including the terminal apparatus 102 associated with the network connection circuitry 118. The network connection circuitry 118 may be configured to join the existing secondary network based at least in part on an evaluation of the criteria and/or rules contained in the extended ANDSF MO.

According to some embodiments, the network connection circuitry 118 may be configured to establish a new secondary network. For example, the network connection circuitry 118 may establish a secondary network (e.g., an ad hoc LAN) with one or more neighboring terminal apparatuses 102 and/or other devices. The network connection circuitry 118 may be configured to establish the new secondary network based at least in part on an evaluation of the criteria and/or rules contained in the extended ANDSF MO.

In various embodiments, the network connection circuitry 118 may be configured to activate the associated terminal apparatus 102 for operation in the secondary network. According to example embodiments, the network connection circuitry 118 may discover and/or establish links to other terminal apparatuses 102 connected to or seeking to connect to the secondary network. The links may be established based at least in part on the criteria and/or rules in the ANDSF MO. In various embodiments, the network connection circuitry 118 may be configured to exchange information with one or more terminal apparatuses 102 operating in the secondary network. The exchanged information may include, for example, address information for the terminal apparatus 102 in the primary network, capabilities for cooperative communications, and/or the like. The network connection circuitry 118 may be configured to provide for transmission of information to a serving network apparatus 104, for example a base station in a primary network to which the terminal apparatus 102 associated with the network connection circuitry 118 is connected, reporting the links and/or data transmission resources available to the secondary network. For example, the network connection circuitry 118 may provide an indication of the links to other terminal apparatuses 102 in the secondary network, capabilities for performing cooperative communications with one or more of the terminal apparatuses 102, and/or the like.

In certain embodiments, the network connection circuitry 118 may be configured to join an existing secondary network or establish a new secondary network in instances in which the network connection circuitry 118 is not required to do by the extended ANDSF MO. In this regard, the network connection circuitry 118 may voluntarily join an existing secondary network or establish a new secondary network even in instances in which the criteria and/or rules of the extended ANDSF MO are not met. In some instances, the network connection circuitry 118 may voluntarily join an existing secondary network or establish a new secondary network based at least in part on input received from a user. For example, in an instance in which the terminal apparatus 102 associated with the network connection circuitry 118 does not meet the minimum battery requirements of the extended ANDSF MO, a user of the terminal apparatus 102 may still wish to join an existing secondary network or establish a new secondary network, and may provide input to the terminal apparatus 102 requesting such an action. In other embodiments, the network connection circuitry 118 may voluntarily decide not to join an existing secondary network or establish a new secondary network even in instances in which the criteria and/or rules of the extended AND SF MO are not met.

According to example embodiments, the network connection circuitry 118 may be configured to perform cooperative communications with one or more terminal apparatuses 102 in the secondary network. For example, the network connection circuitry 118 may cooperate with one or more terminal apparatuses 102 in the secondary network to perform cooperative multiple-input and multiple-output (MIMO) communications with the primary network. In this regard, the network connection circuitry 118 may be configured to transmit and/or receive data simultaneously, or nearly simultaneously, with one or more neighboring terminal apparatuses 102. In other embodiments, the network connection circuitry 118 may be configured to transmit and/or receive data with one or more neighboring terminal apparatuses 102 at different times. According to example embodiments, the network connection circuitry 118, in some instances in cooperation with other terminal apparatuses 102 connected to the secondary network, may be configured to evaluate and identify the devices and/or transmitters available within the secondary network best suited for cooperative communications with the primary network. For example, the network connection circuitry 118 may determine which devices and/or transmitters have the best signal strength, highest throughput, and/or the like. In some instances, this determination may be performed by a serving network apparatus 104 in the primary network. The network connection circuitry 118 may be configured to use this information to determine which devices and/or transmitters should perform the cooperative communications or to which devices communications should be offloaded.

With respect to transmitting data, the network connection circuitry 118 may be configured to distribute data to be transmitted to one or more terminal apparatuses 102 in the secondary network. For example, the network connection circuitry 118 may be configured to distribute data to one or more of the terminal apparatuses 102 in the secondary network that also have a connection to the primary network. The serving network apparatus 104 receiving this data may be aware of the one or more terminal apparatuses 102 connected to the secondary network to be able to recognize which terminal apparatuses 102 may transmit the data in cooperation with the terminal apparatus 102 associated with the network connection circuitry 118. In these embodiments, the network connection circuitry 118 and the one or more terminal apparatuses 102 in the secondary network may be configured to simultaneously transmit the distributed data to a serving network apparatus 104 in the network 106 (e.g. in a primary network to which the terminal apparatuses 102 of the secondary network are also connected). In this regard, the antennae from the terminal apparatus 102 associated with the network connection circuitry 118 and the one or more terminal apparatuses 102 in the secondary network may be used to simultaneously transmit the same data to a single receiving serving network apparatus 104 in the primary network. The network connection circuitry 118 may be configured to reduce the typical transmission power used to transmit data based at least in part on the ability to use the terminal apparatuses 102 in the secondary network to help transmit the data. In other embodiments, the network connection circuitry 118 and/or the one or more terminal apparatuses 102 in the secondary network may be configured to transmit the distributed data to a serving network apparatus 104 in the network 106 at different times.

According to example embodiments, the terminal apparatuses 102 may simultaneously transmit separate spatial streams at the same frequency and time resource. For example, each of the terminal apparatuses 102 may transmit separate data, and the total throughput of the spatial streams may exceed the throughput of a single link from a single terminal apparatus 102. In this regard, the cooperative use of antennas from each of the participating terminal apparatuses 102 may allow a greater amount of data to be transmitted than by a single terminal apparatus 102 due at least in part to the larger number of antennas and therefore the larger amount of spatial streams that may be handled. In other embodiments, the network connection circuitry 118 associated with each respective terminal apparatus 102 may be configured to receive a command from a serving network apparatus 104 indicating whether the terminal apparatus 102 should participate in a particular cooperative communication. For example, the network connection circuitry 118 may receive a command indicating that the associated terminal apparatus 102 should participate in the cooperative communication in an instance in which the associated terminal apparatus 102 currently has an optimal link to the serving network apparatus 104. According to various embodiments, the terminal apparatuses 102 may be configured to operate in one or more of the defined transmission mechanisms. In these embodiments, the network connection circuitry 118 associated with each respective terminal apparatus 102 may be configured to receive a command from the serving network apparatus 104 indicating the transmission mechanism for each particular transmission.

With respect to receiving data, the network connection circuitry 118 may be configured to receive data from a serving network apparatus 104 in cooperation with one or more terminal apparatuses 102 in the secondary network. For example, the network connection circuitry 118 may be configured to receive data from one or more of the terminal apparatuses 102 in the secondary network that also have a connection to the primary network. The serving network apparatus 104 transmitting this data may be aware of the one or more terminal apparatuses 102 connected to the secondary network to be able to recognize which terminal apparatuses 102 may be configured to receive the data in cooperation with the terminal apparatus 102 associated with the network connection circuitry 118. In these embodiments, the network connection circuitry 118 and the one or more terminal apparatuses 102 in the secondary network may be configured to simultaneously receive the data from a serving network apparatus 104 in the network 106 (e.g. in a primary network to which the terminal apparatuses 102 of the secondary network are also connected). In this regard, the antennae from the terminal apparatus 102 associated with the network connection circuitry 118 and the one or more terminal apparatuses 102 in the secondary network may be used to simultaneously receive the same data from a single receiving serving network apparatus 104 in the network 106. The network connection circuitry 118 may be configured to collect the received data from the one or more terminal apparatuses 102 in the network 106. In other embodiments, the network connection circuitry 118 and/or the one or more terminal apparatuses 102 in the secondary network may be configured to receive the data from a serving network apparatus 104 in the network 106 at different times.

According to example embodiments, the terminal apparatuses 102 may simultaneously receive separate spatial streams that are transmitted at the same frequency and time resource. For example, each of the terminal apparatuses 102 may receive separate data, and the total throughput of the spatial streams may exceed the throughput of a single link from a single terminal apparatus 102. In this regard, the cooperative use of antennas from each of the participating terminal apparatuses 102 may allow a greater amount of data to be received than by a single terminal apparatus 102 due at least in part to the larger number of antennas and therefore the larger amount of spatial streams that may be handled. In other embodiments, the network connection circuitry 118 associated with each respective terminal apparatus 102 may receive data from a serving network apparatus 104 in an instance in which the serving network apparatus 104 decides that the terminal apparatus 102 should participate in a particular cooperative communication. For example, the network connection circuitry 118 may receive data in an instance in which the associated terminal apparatus 102 currently has an optimal link to the serving network apparatus 104. According to various embodiments, the terminal apparatuses 102 may be configured to operate in one or more of the defined transmission mechanisms. In these embodiments, the network connection circuitry 118 associated with each respective terminal apparatus 102 may be configured to receive a command from the serving network apparatus 104 indicating the transmission mechanism for each particular transmission.

In some embodiments, the network connection circuitry 118 may be configured not to simultaneously transmit and receive data with the one or more terminal apparatuses 102 in the network 106. In these embodiments, the network connection circuitry 118 may be configured to distribute the data to be transmitted to one or more terminal apparatuses 102 in the secondary network. The one or more terminal apparatuses 102 in the secondary network may transmit the distributed data originating from the network connection circuitry 118, simultaneously with each other or at different times in instances in which more than one terminal apparatus 102 in the network 106 is participating, to a serving network apparatus 104 without assistance from the network connection circuitry 118. Similarly, the one or more terminal apparatuses 102 in the secondary network may receive data destined for the network connection circuitry 118, simultaneously with each other or at different times in instances in which more than one terminal apparatus 102 in the network 106 is participating, from a serving network apparatus 104 without assistance from the network connection circuitry 118. In these embodiments, the network connection circuitry 118 may receive the received data from the one or more terminal apparatuses 102. According to example embodiments, the one or more terminal apparatuses 102 in the secondary network may be connected to a different serving network apparatus 104 (e.g., a different base station in the primary network or a different primary network entirely) than the terminal apparatus 102 associated with the network connection circuitry 118. In these embodiments, the network connection circuitry 118 may offload its data communications to the one or more terminal apparatuses 102 in the secondary network as described above in order to offload the data communications to a different serving network apparatus 104 (i.e., the serving network apparatus 104 associated with the one or more terminal apparatuses 102 in the secondary network).

According to example embodiments, the network connection circuitry 118 may be configured to transmit and receive data originating with and/or destined for a neighboring terminal apparatus 102. In some instances, the network connection circuitry 118 may be configured to provide for coordinated communications related to the data originating with or destined for the neighboring terminal apparatus 102 with assistance from other neighboring terminal apparatuses 102.

In certain embodiments, the network connection circuitry 118 may be configured to communicate with more than one serving network apparatus 104. In this regard, the multiple serving network apparatuses 104 may be configured to provide for cooperative MIMO communications similar to the methods described above with respect to the terminal apparatuses 102 in the secondary network, as well as the terminal apparatus 102 associated with the network connection circuitry 118 in some instances. That is, the multiple serving network apparatuses 104 may be configured to simultaneously transmit and receive the data to and/or from the network connection circuitry 118.

According to various embodiments, the network connection circuitry 118 may be configured to join an existing secondary network or establish a new secondary network for purposes other than cooperative communication. In example embodiments, the purpose of the secondary network may be indicated or specified by a distribution type element in the extended ANDSF MO. The network connection circuitry 118, in some instances, may be configured to join or create a secondary network to provide a portal for Internet access to an area. Some embodiments may allow the network connection circuitry 118 to join or establish a secondary network for application data distribution. In certain embodiments, the network connection circuitry 118 may be configured to join or establish a secondary network to facilitate local sharing, local social networking, and/or the like among neighboring terminal apparatuses 102. In other embodiments, the network connection circuitry 118 may join or establish a secondary network to assist with television white spaces (e.g., ultra high frequency (UHF) television white spaces). It should be noted that the primary and secondary networks may not have the same meaning as in television white spaces or cognitive radios, where a primary network may refer to the primary user of the spectrum and a secondary network may refer to the secondary user of the spectrum if it is available for secondary use.

In some embodiments, the network connection circuitry 118 may be configured to disconnect from the secondary network. For example, the network connection circuitry 118 may evaluate the extended ANDSF MO and determine that the criteria for connection to a secondary network are no longer met. In this regard, the network connection circuitry 118 may be configured to drop the connection to the secondary network, or in instances in which the network connection circuitry 118 established the secondary network, to terminate beaconing which may result in elimination of the secondary network entirely. In example embodiments, the network connection circuitry 118 may be configured to change to a different secondary network or to create another secondary network upon disconnecting from the previous secondary network, in some instances based on the extended ANDSF MO.

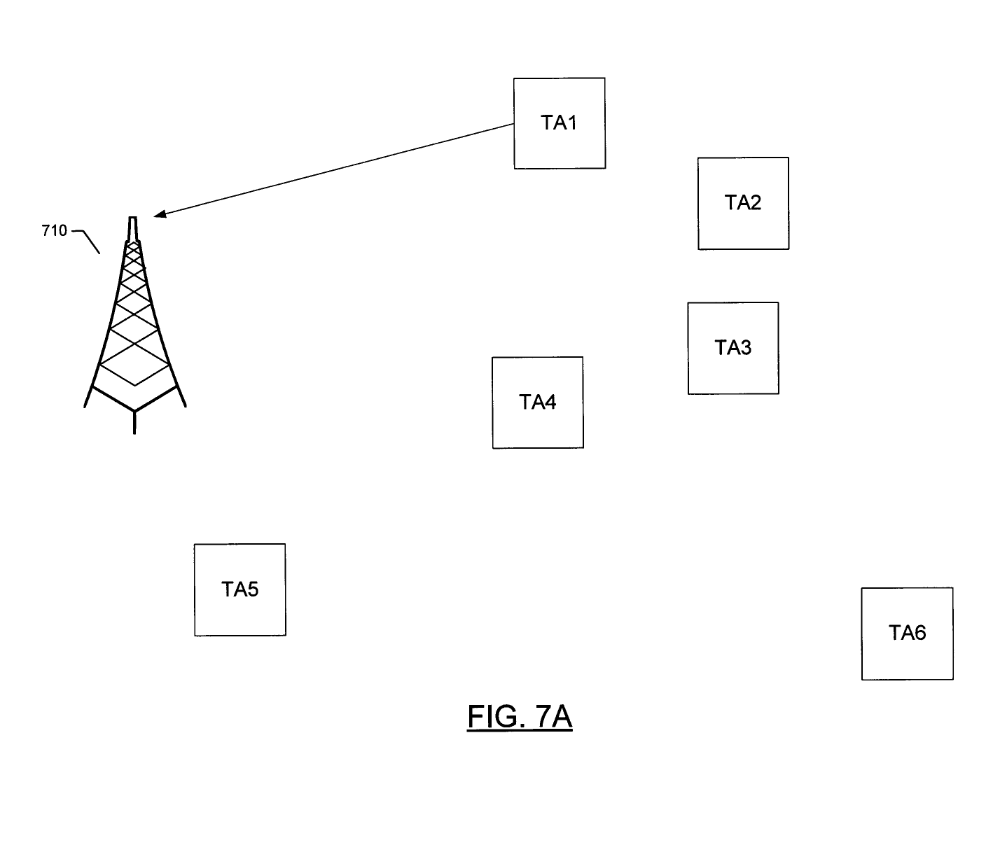

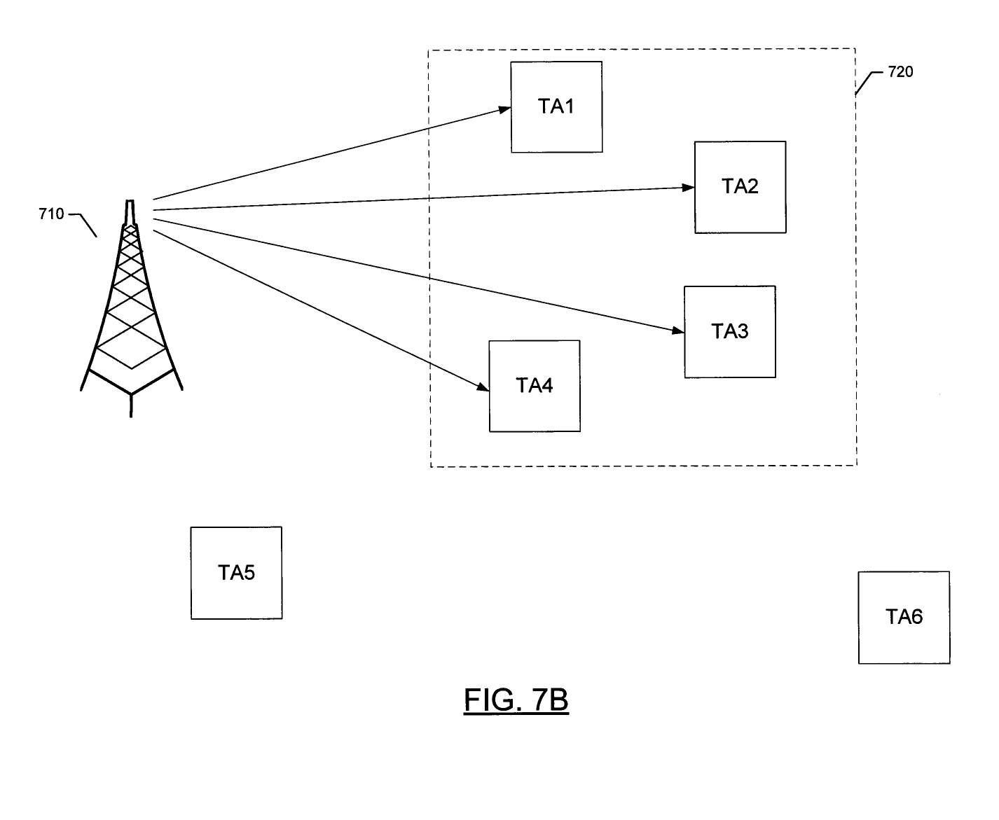

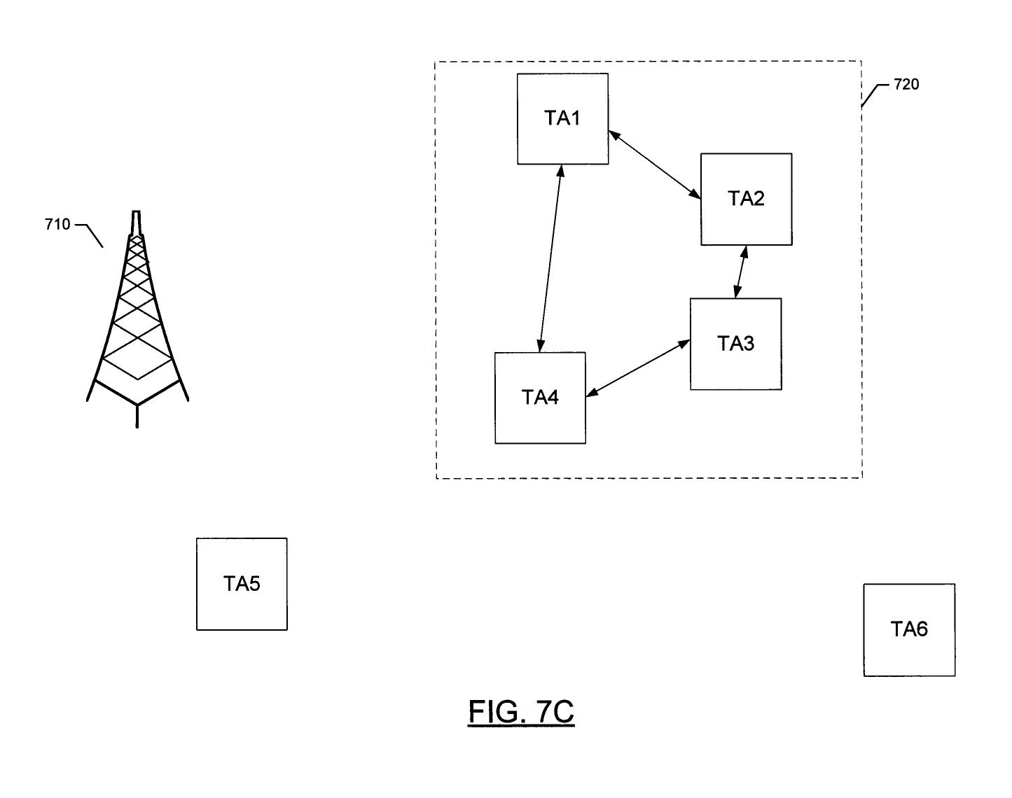

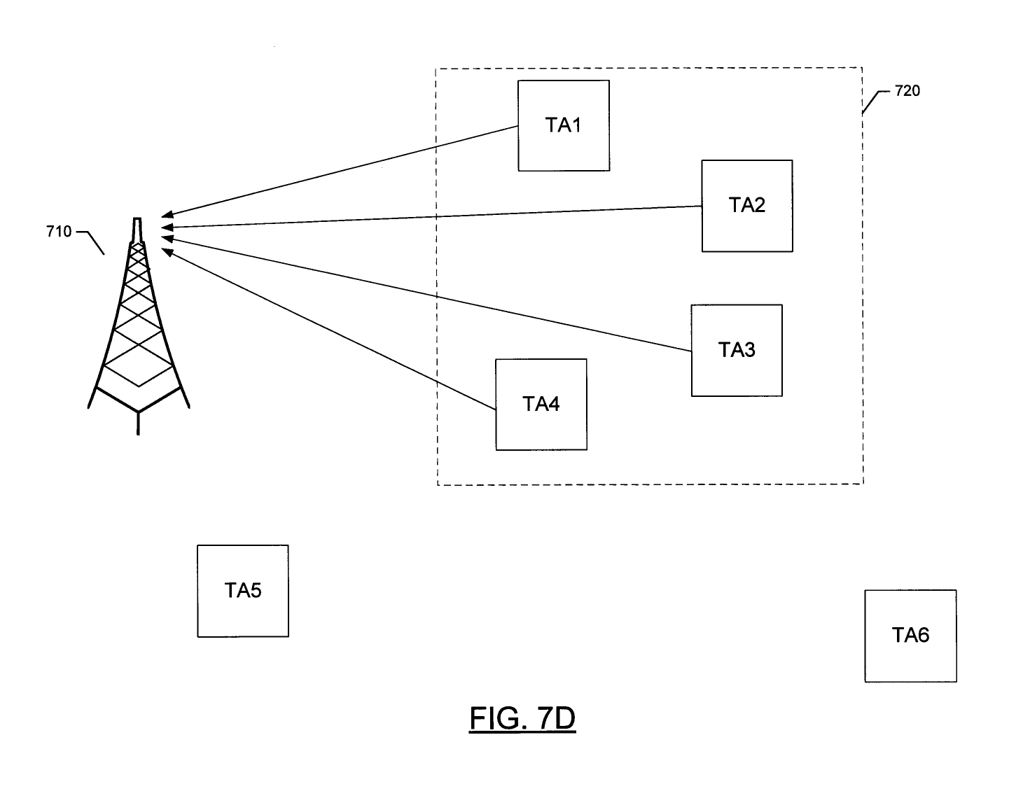

FIGS. 7A through 7D illustrate several of the above functions of the network connection circuitry, according to an example embodiment. It should be understood that the functions illustrated in FIGS. 7A through 7D and hereinafter described are merely illustrative of one example embodiment and, therefore, should not be taken to limit the scope of the disclosure.

FIG. 7A illustrates a system comprising a serving network apparatus, namely base station 710, of a WAN and several terminal apparatuses, labeled TA1 through TA6. As shown in FIG. 7A, a terminal apparatus, such as TA1, may communicate with the base station 710 in order to establish a connection with the WAN. While not illustrated in FIG. 7A, one or more of the remaining terminal apparatuses may also connect to the base station 710.

FIG. 7B illustrates several terminal apparatuses, namely TA1 through TA4, receiving configuration information from base station 710. In the example embodiment, the configuration information indicates that terminal apparatuses TA1 through TA4 should join and/or form ad hoc local area network 720. Terminal apparatuses TA5 and TA6 may similarly receive the configuration information; however, in this example embodiment TA5 and TA6 do not meet the criteria for joining the ad hoc LAN 720.

In FIG. 7C, one of the terminal apparatuses TA1 through TA4 belonging to the ad hoc LAN 720 may desire to transmit data to the base station. In this example embodiment, the originating terminal apparatus, for example TA1, may first distribute a copy of the data to each of the other terminal apparatuses in the ad hoc LAN 720. As shown in FIG. 7C, each terminal apparatus does not need to establish a direct link with every other terminal apparatus in the ad hoc LAN 720, though in other embodiments they might. Once the data for transmission has been distributed to all of the other terminal apparatuses participating in cooperative communication with TA1, FIG. 7D illustrates each of the participating terminal apparatuses TA1 through TA4 sending the same data to the base station 710. Though not shown in this example embodiment, the base station 710 may similarly transmit data destined for TA1 to all of the terminal apparatuses in the ad hoc LAN 720, namely TA1 through TA4, which would then provide the data to TA1.

The present invention further envisions a Real Time Secondary Access Network Discovery and Selection Function (RTSANDSF). In various embodiments, the network connection circuitry 118 may be configured to receive real time information from the RTSANDSF, in some instances via one or more intervening serving network apparatuses 104, rather than relying on the static ANDSF MO. The network connection circuitry 118 may perform the same operations as those described above with respect to the extended ANDSF MO (e.g., joining or establishing a LAN), but in response to real time commands from the RTSANDSF. In example embodiments, the network connection circuitry 118 may be configured to both download the extended ANDSF MO and receive information from the RTSANDSF. In these embodiments, the commands received from the RTSANDSF may supersede the criteria and rules set forth in the extended ANDSF MO. In other embodiments, the network connection circuitry 118 may be configured not to download the extended ANDSF MO in addition to receiving information from the RTSANDSF.

According to various embodiments, the network connection circuitry 118 may be configured to provide real time information (e.g., status updates) to the RTSANDSF, in some instances via one or more intervening serving network apparatuses 104. For example, the network connection circuitry 118 may provide real time location updates to the RTSANDSF. In some instances, the RTSANDSF may not receive any additional information from the network connection circuitry 118 beyond standard network communications. The RTSANDSF, in certain embodiments, may use the information provided by the network connection circuitry 118 to determine the commands to be provided to the network connection circuitry 118. For example, the commands may be based at least in part on the throughput of the terminal apparatuses 102 in the network 106, number of transceivers available, number of antennae available, device types of the terminal apparatuses 102, contracts between the terminal apparatuses 102 and their respective network providers, and/or the like. The network connection circuitry 118 may provide for transmission of the status updates to the RTSANDSF, in some embodiments, when information has changed or in response to receiving a request from the RTSANDSF.

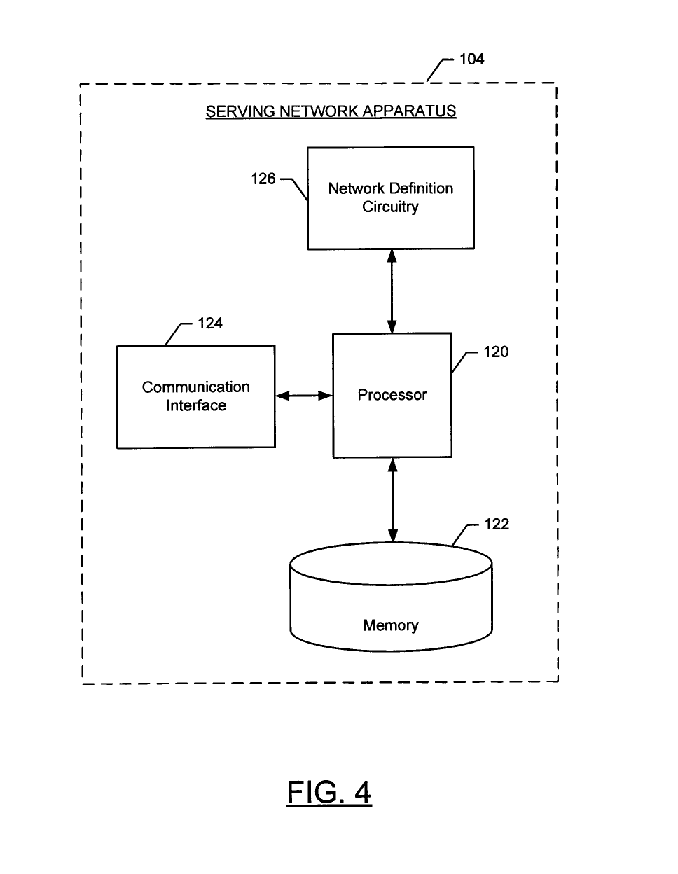

FIG. 4 illustrates a block diagram of a serving network apparatus 104 according to an example embodiment. In the example embodiment, the serving network apparatus 104 includes various means for performing the various functions herein described. These means may comprise one or more of a processor 120, memory 122, communication interface 124, or network definition circuitry 126. The means of the serving network apparatus 104 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g., memory 122) that is executable by a suitably configured processing device (e.g., the processor 120), or some combination thereof.

In some example embodiments, one or more of the means illustrated in FIG. 4 may be embodied as a chip or chip set. In other words, the serving network apparatus 104 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 120, memory 122, communication interface 124, and/or network definition circuitry 126 may be embodied as a chip or chip set. The serving network apparatus 104 may therefore, in some example embodiments, be configured to implement embodiments of the present invention on a single chip or as a single “system on a chip.” As another example, in some example embodiments, the serving network apparatus 104 may comprise component(s) configured to implement embodiments of the present invention on a single chip or as a single “system on a chip.” As such, in some cases, a chip or chipset may constitute means for performing one or more operations for providing the functionalities described herein.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 4 as a single processor, in some embodiments the processor 120 comprises a plurality of processors. The plurality of processors may be in operative communication with each other and may be collectively configured to perform one or more functionalities of the serving network apparatus 104 as described herein. The plurality of processors may be embodied on a single computing device or distributed across a plurality of computing devices collectively configured to function as the serving network apparatus 104. In some example embodiments, the processor 120 is configured to execute instructions stored in the memory 122 or otherwise accessible to the processor 120. These instructions, when executed by the processor 120, may cause the serving network apparatus 104 to perform one or more of the functionalities of the serving network apparatus 104 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may comprise, for example, volatile memory, non-volatile memory, or some combination thereof. In this regard, the memory 122 may comprise a non-transitory computer-readable storage medium. Although illustrated in FIG. 4 as a single memory, the memory 122 may comprise a plurality of memories. The plurality of memories may be embodied on a single computing device or may be distributed across a plurality of computing devices collectively configured to function as the serving network apparatus 104. In various example embodiments, the memory 122 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the serving network apparatus 104 to carry out various functions in accordance with various example embodiments. For example, in some example embodiments, the memory 122 is configured to buffer input data for processing by the processor 120. Additionally or alternatively, the memory 122 may be configured to store program instructions for execution by the processor 120. The memory 122 may store information in the form of static and/or dynamic information. This stored information may be stored and/or used by the network definition circuitry 126 during the course of performing its functionalities.

The communication interface 124 may be embodied as any device or means embodied in circuitry, hardware, a computer program product comprising computer readable program instructions stored on a computer readable medium (for example, the memory 122) and executed by a processing device (for example, the processor 120), or a combination thereof that is configured to receive and/or transmit data from/to another computing device. In an example embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with one or more remote computing devices. The communication interface 124 may be configured to receive and/or transmit data using any protocol that may be used for communications between computing devices. In this regard, the communication interface 124 may be configured to receive and/or transmit data using any protocol that may be used for transmission of data over a wireless network, wireline network, some combination thereof, or the like by which the serving network apparatus 104 and one or more computing devices or computing resources may be in communication. As an example, the communication interface 124 may be configured to enable communication with a terminal apparatus 102 by the network 106, a radio uplink, and/or the like. The communication interface 124 may additionally be in communication with the memory 122, and/or network definition circuitry 126, such as via a bus.

The network definition circuitry 126 may be embodied as various means, such as circuitry, hardware, a computer program product comprising computer readable program instructions stored on a computer readable medium (for example, the memory 122) and executed by a processing device (for example, the processor 120), or some combination thereof and, in some embodiments, is embodied as or otherwise controlled by the processor 120. In embodiments wherein the network definition circuitry 126 is embodied separately from the processor 120, the network definition circuitry 126 may be in communication with the processor 120. The network definition circuitry 126 may further be in communication with one or more of the memory 122 or communication interface 124, such as via a bus.

In some example embodiments, the network definition circuitry 126 may be configured to provision one or more terminal apparatuses 102 with network service according to a given network standard. For example, the network definition circuitry 126 may be configured to operate according to the LTE standard.

According to example embodiments, the network definition circuitry 126 may be associated with a serving network apparatus 104 configured to operate as an ANDSF. In other embodiments, the network definition circuitry 126 may be associated with a serving network apparatus 104 configured to operate as an entity of a primary network, or WAN (e.g., a base station). In these embodiments, the serving network apparatus 104 associated with the network definition circuitry 126 may be located in the network path between an AND SF and one or more terminal apparatus 102 associated with the primary network. According to certain embodiments, the serving network apparatus 104 associated with the network definition circuitry 126 may be configured to operate as both an ANDSF and a base station. The serving network apparatus 104 associated with the network definition circuitry 126 may be configured to provide for transmission of an ANDSF MO (e.g., the extended ANDSF MO described above) to one or more of the terminal apparatuses 102 associated with the primary network. The ANDSF MO may originate from the serving network apparatus 104 associated with the network definition circuitry 126, or in some instances the ANDSF MO may be provided to the serving network apparatus 104 associated with the network definition circuitry 126 by another entity in the network.

In various embodiments, the network definition circuitry 126 may configure the ANDSF MO. In this regard, the network definition circuitry 126 may configure the ANDSF MO based at least in part on information related to the terminal apparatuses 102 in the network 106 and/or the network 106 itself. For example, the network definition circuitry 126 may determine the criteria and/or rules (e.g., time, location, etc.) of the ANDSF MO which direct the terminal apparatuses 102 to join or establish a secondary network. The network definition circuitry 126 may determine the criteria and/or rules, in some instances, based on the number of terminal apparatuses 102 in the network, the size and/or capacity of the network, the areas of the network most likely to have a concentration of terminal apparatuses 102 at any given point, the strength of signal in the various areas covered by the network, and/or other factors.

According to certain embodiments, the network definition circuitry 126 may be configured to maintain information related to the terminal apparatuses 102 in the network 106. The network definition circuitry 126 may, in example embodiments, be configured to request and/or receive the information from the one or more terminal apparatuses 102 (e.g., status updates). For example, the network definition circuitry 126 may be configured to receive an indication of the links between terminal apparatuses 102 in the secondary network, capabilities of the terminal apparatuses 102 for performing cooperative communications with one another, and/or the like. In some embodiments, the network definition circuitry 126 may receive an indication that a terminal apparatus 102 desires to perform cooperative communications, and in some instances an indication of the other terminal apparatuses 102 that will participate. The network definition circuitry 126 may maintain, in some embodiments, information about the one or more secondary networks joined or established by the terminal apparatuses 102 in the network. In this regard, the network definition circuitry 126 may maintain information about one or more static secondary networks in the network and/or one or more ad hoc secondary networks.

In some embodiments, the network definition circuitry 126 may be configured to handle simultaneous or nearly simultaneous cooperative communications from more than one terminal apparatus 102 in the network. In other embodiments, the cooperative communications may not be simultaneous. Similar to the functionality described above with respect to the network connection circuitry 118 of the terminal apparatuses 102, the network definition circuitry 126 may be configured to receive data originating from a single terminal apparatus 102 from more than one terminal apparatus 102 in the network. The network definition circuitry 126 may then process the received data. The network definition circuitry 126 may, in example embodiments, be configured to transmit data destined for a single terminal apparatus 102 to more than one terminal apparatus 102 in the network. The terminal apparatuses 102 may process and/or provide the received data to the terminal apparatus 102 to which it is destined.

According to certain embodiments, the network definition circuitry 126 may be configured to provide for simultaneous, or nearly simultaneous, cooperative communications with one or more neighboring serving network apparatuses 104. Again, as described above with respect to the network connection circuitry 118, the network definition circuitry 126 may be configured to distribute data to be transmitted by one or more neighboring serving network apparatuses 104 to a single terminal apparatus 102 and/or to collect data from one or more neighboring serving network apparatuses 104 having been received by each from a single terminal apparatus 102.

In some embodiments, the serving network apparatus 104 associated with the network definition circuitry 126 may be configured to operate as an RTSANDSF. In this regard, the network definition circuitry 126 may be configured to track information about the terminal apparatuses 102 in the network 106, the secondary networks in the network 106, and information about the network itself, in real time. For example, the network definition circuitry 126 may maintain location information for one or more of the terminal apparatuses 102, the number of secondary networks in the network 106 as well as their location and participating terminal apparatuses 102, the current capacity and congestion of the secondary networks as well as the primary network or other network 106 to which the serving network apparatus 104 associated with the network definition circuitry 126 belongs, and/or the like. In example embodiments, the network definition circuitry 126 may cause storage of this information in a memory or database.

In various embodiments, the network definition circuitry 126 may obtain an indication of temporarily available network resources and may perform load balancing between primary networks. In these example embodiments, the network definition circuitry 126 may provide for transmission of a command to selected terminal apparatuses 102 to connect to a different serving network apparatus 104, to avoid connection to or to disconnect from one or more serving network apparatuses 104 that may be congested, and/or to establish new secondary networks, such as ad hoc LANs. The network definition circuitry 126 may, in certain instances, provide these commands in an instance in which the maintenance of the existing secondary network results in exceeding a particular power consumption threshold, the operation of the existing secondary network exceeds a particular overhead threshold due to the number of terminal apparatuses 102 in the secondary network, the coverage of the secondary network exceeds a particular size threshold, the consumption of available transmission resources exceeds a particular consumption threshold, and/or the like.

According to embodiments in which the serving network apparatus 104 associated with the network definition circuitry 126 is configured to operate as an RTSANDSF, the network definition circuitry 126 may transmit commands in real time to the one or more terminal apparatuses 102 in the network 106 rather than relying on a transmitting a static ANDSF MO to the terminal apparatuses 102. For example, the network definition circuitry 126 may command that one or more terminal apparatuses 102 perform network discovery, connect to an existing secondary network, establish a new secondary network, connect to a different secondary network (e.g., in order to combine/divide secondary networks into larger/smaller or greater/fewer secondary networks), offload communications to a secondary networks (e.g., an ad hoc LAN, mesh, D2D, or the like), handover to another serving network apparatus 104 in the network 106 or a different network, and/or the like.

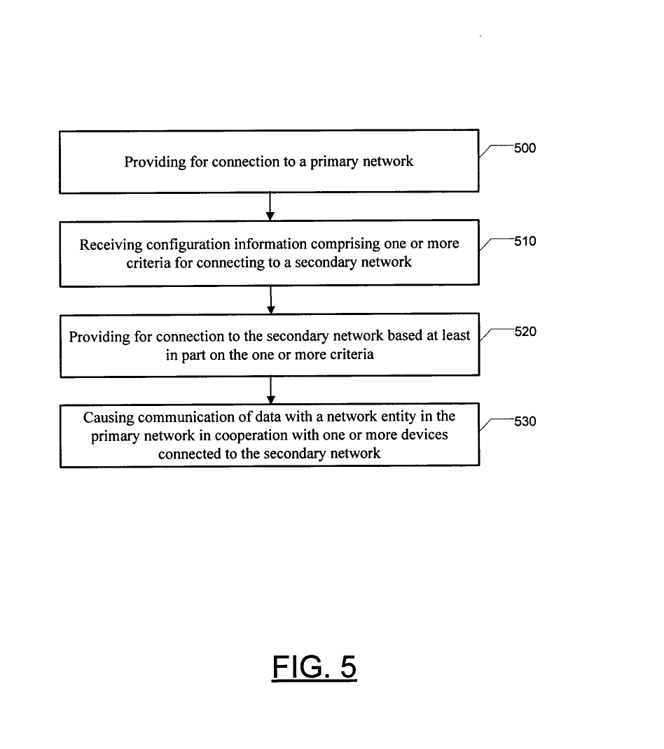

FIG. 5 illustrates a flowchart according to an example method for implementing secondary networks for cooperative communications with a primary network according to an example embodiment. In this regard, FIG. 5 illustrates operations that may be performed at a terminal apparatus 102. The operations illustrated in and described with respect to FIG. 5 may, for example, be performed by, with the assistance of, and/or under the control of one or more of the processor 110, memory 112, communication interface 114, or network connection circuitry 118. Operation 500 may comprise providing for connection to a primary network. The processor 110, memory 112, communication interface 114, user interface 116, and/or network connection circuitry 118 may, for example, provide means for performing operation 500. Operation 510 may comprise receiving configuration information comprising one or more criteria for connecting to secondary network. The processor 110, memory 112, communication interface 114, user interface 116, and/or network connection circuitry 118 may, for example, provide means for performing operation 510. Operation 520 may comprise providing for connection to the secondary network based at least in part on the one or more criteria. The processor 110, memory 112, communication interface 114, user interface 116, and/or network connection circuitry 118 may, for example, provide means for performing operation 520. Operation 530 may comprise causing communication of data with a network entity in the primary network in cooperation with one or more devices connected to the secondary network. The processor 110, memory 112, communication interface 114, user interface 116, and/or network connection circuitry 118 may, for example, provide means for performing operation 530.

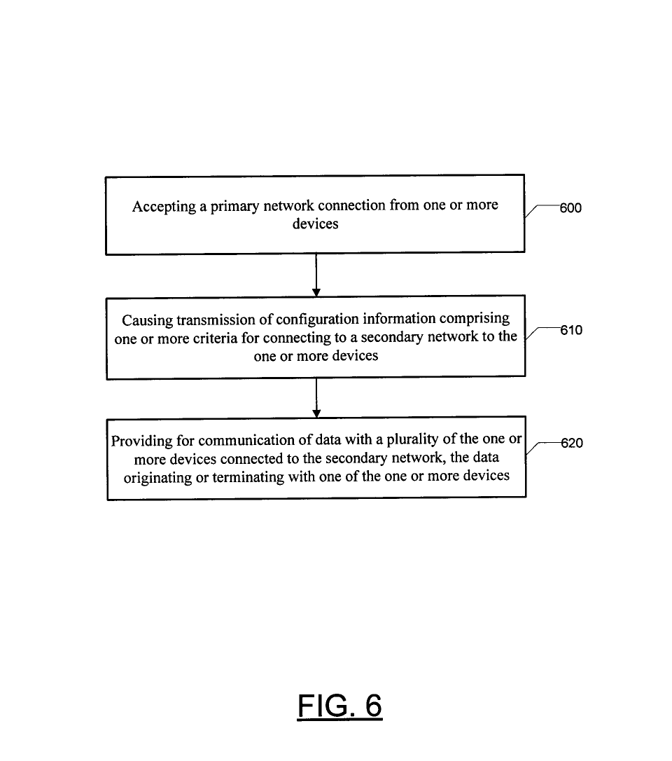

FIG. 6 illustrates a flowchart according to another example method for implementing secondary networks for cooperative communications with a primary network according to an example embodiment. In this regard, FIG. 6 illustrates operations that may be performed at a serving network apparatus 104. The operations illustrated in and described with respect to FIG. 6 may, for example, be performed by, with the assistance of, and/or under the control of one or more of the processor 120, memory 122, communication interface 124, or network definition circuitry 126. Operation 600 may comprise accepting a primary network connection from one or more devices. The processor 120, memory 122, communication interface 124, and/or network definition circuitry 126 may, for example, provide means for performing operation 600. Operation 610 may comprise causing transmission of configuration information to the one or more devices. The configuration information may comprise one or more criteria for connecting to a secondary network. The processor 120, memory 122, communication interface 124, and/or network definition circuitry 126 may, for example, provide means for performing operation 610. Operation 620 may comprise providing for communication of data with a plurality of the one or more devices. The data may originate or terminate with one of the one or more devices, and the plurality of the one or more devices may be connected to the secondary network. The processor 120, memory 122, communication interface 124, and/or network definition circuitry 126 may, for example, provide means for performing operation 620.

FIGS. 5-6 each illustrate a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums (as opposed to a computer-readable transmission medium which describes a propagating signal) having one or more computer program code instructions, program instructions, or executable computer-readable program code instructions stored therein. For example, one or more of the procedures described herein may be embodied by computer program instructions of a computer program product. In this regard, the computer program product(s) that embodies the procedures described herein may be stored by one or more memory devices (e.g., memory 122, volatile memory 40, or non-volatile memory 42) of a mobile terminal, server, or other computing device (e.g., the terminal apparatus 102) and executed by a processor (e.g., the processor 120 or processor 20) in the computing device. In some embodiments, the computer program instructions comprising the computer program product(s) that embodies the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s).

Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together.

Accordingly, execution of instructions associated with the operations of the flowchart by a processor, or storage of instructions associated with the blocks or operations of the flowchart in a computer-readable storage medium, support combinations of operations for performing the specified functions. It will also be understood that one or more operations of the flowchart, and combinations of blocks or operations in the flowchart, may be implemented by special purpose hardware-based computer systems and/or processors which perform the specified functions, or combinations of special purpose hardware and program code instructions.

The above described functions may be carried out in many ways. For example, any suitable means for carrying out each of the functions described above may be employed to carry out embodiments of the invention. In one embodiment, a suitably configured processor (for example, the processor 110 and/or processor 120) may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium (for example, the memory 112 and/or memory 122), and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1-42. (canceled)

43. A method comprising:
providing for connection to a primary network;
receiving configuration information comprising one or more criteria for connecting to a secondary network;
providing for connection to the secondary network based at least in part on the one or more criteria; and
causing communication of data with a network entity in the primary network in cooperation with one or more devices connected to the secondary network.

44. The method of claim 43, wherein receiving configuration information further comprises:
receiving an access network discovery and selection function management object.

45. The method of claim 43, wherein receiving configuration information further comprises:
receiving one or more real time commands originating from a real time secondary access network discovery and selection function.

46. The method of claim 43, wherein causing communication with a network entity in the primary network in cooperation with one or more devices connected to the secondary network further comprises at least one of:
distributing data for transmission to the one or more devices connected to the secondary network; and
causing transmission of the data to the network entity in cooperation with the one or more devices connected to the secondary network;
or
receiving data from the network entity in cooperation with the one or more devices connected to the secondary network; and
collecting the received data from the one or more devices connected to the secondary network.

47. The method of claim 43, wherein providing for connection to the secondary network further comprises:
forming the secondary network;
discovering at least one device; and
creating a link to the at least one device in the secondary network.

48. The method of claims 43 further comprising:
causing transmission of network information to the network entity in the primary network, wherein the network information comprises information related to the secondary network.

49. The method of claim 43 wherein the secondary network comprises a link to an offload network, the method further comprising:
communicating data via the link to the offload network instead of causing communication with a network entity in the primary network.

50. An apparatus comprising:
at least one processor; and
at least one memory comprising computer program code, the at least one memory and the computer program code configured to, with the at least one processor, cause the apparatus at least to:
provide for connection to a primary network;
receive configuration information comprising one or more criteria for connecting to a secondary network;
provide for connection to the secondary network based at least in part on the one or more criteria; and
cause communication of data with a network entity in the primary network in cooperation with one or more devices connected to the secondary network.

51. The apparatus of claim 50, wherein in order to receive configuration information, the at least one memory and the computer program code are further configured to, with the at least one processor, cause the apparatus to:
receive an access network discovery and selection function management object.

52. The apparatus of claim 50, wherein in order to receive configuration information, the at least one memory and the computer program code are further configured to, with the at least one processor, cause the apparatus to:
receive one or more real time commands originating from a real time secondary access network discovery and selection function.

53. The apparatus of claim 50, wherein in order to cause communication with a network entity in the primary network in cooperation with one or more devices connected to the secondary network, the at least one memory and the computer program code are further configured to, with the at least one processor, cause the apparatus to perform at least one of:
distribute data for transmission to the one or more devices connected to the secondary network; and
cause transmission of the data to the network entity in cooperation with the one or more devices connected to the secondary network;
or
receive data from the network entity in cooperation with the one or more devices connected to the secondary network; and
collect the received data from the one or more devices connected to the secondary network.

54. The apparatus of claim 50, wherein in order to provide for connection to the secondary network, the at least one memory and the computer program code are further configured to, with the at least one processor, cause the apparatus to:
form the secondary network;
discover at least one device; and
create a link to the at least one device in the secondary network.

55. The apparatus of claim 50, wherein the at least one memory and the computer program code are further configured to, with the at least one processor, cause the apparatus to:
cause transmission of network information to the network entity in the primary network, wherein the network information comprises information related to the secondary network.

56. The apparatus of claim 50, wherein the secondary network comprises a link to an offload network, and wherein at least one memory and the computer program code are further configured to, with the at least one processor, cause the apparatus to:
communicate data via the link to the offload network instead of causing communication with a network entity in the primary network.

57. A method comprising:
accepting a primary network connection from one or more devices;
causing transmission of configuration information to the one or more devices, wherein the configuration information comprises one or more criteria for connecting to a secondary network;
providing for communication of data with a plurality of the one or more devices, wherein the data originates or terminates with one of the one or more devices, and wherein the plurality of the one or more devices are connected to the secondary network.

58. The method of claim 57, wherein causing transmission of configuration information further comprises:
receiving status information from the one or more devices; and
causing transmission of one or more real time commands to the one or more devices based at least in part on the status information.

59. The method of claim 58, wherein the one or more real time commands comprise at least one of a command to connect to an existing secondary network and a command to form a new secondary network.

60. An apparatus comprising:
at least one processor; and
at least one memory comprising computer program code, the at least one memory and the computer program code configured to, with the at least one processor, cause the apparatus at least to:
accept a primary network connection from one or more devices;
cause transmission of configuration information to the one or more devices, wherein the configuration information comprises one or more criteria for connecting to a secondary network;
provide for communication of data with a plurality of the one or more devices, wherein the data originates or terminates with one of the one or more devices, and wherein the plurality of the one or more devices are connected to the secondary network.

61. The apparatus of claim 60, wherein in order to cause transmission of configuration information, the at least one memory and the computer program code are further configured to, with the at least one processor, cause the apparatus to:
receive status information from the one or more devices; and
cause transmission of one or more real time commands to the one or more devices based at least in part on the status information.

62. The apparatus of claim 61, wherein the one or more real time commands comprise at least one of a command to connect to an existing secondary network and a command to form a new secondary network.
